(19) United States
(12) Patent Application Publication
(10) Pub. No.: US 2025/0344684 A1
(43) Pub. Date: Nov. 13, 2025

(54) Wearable Fishing Reel

(71) Applicant: Justin Rietema, Fort Lauderdale, FL (US)

(72) Inventor: Justin Rietema, Fort Lauderdale, FL (US)

(21) Appl. No.: 19/204,065

(22) Filed: May 9, 2025

Related U.S. Application Data
(60) Provisional application No. 63/644,945, filed on May 9, 2024.

(51) Int. Cl. A01K 89/08; A44C 5/00; A44C 5/20

(52) U.S. Cl. CPC A01K 89/08; A44C 5/0053; A44C 5/2071

(57) ABSTRACT

A wearable fishing reel is a device that can be comfortably worn by the user so that the user can perform simple fishing anywhere anytime. To do so, the device includes a support base, a line spool, a plurality of hook-securing channels, and a restraining strap. The support base corresponds to the structure that facilitates the attachment of the restraining strap to the device. The support base also facilitates the operation of the line spool when performing simple fishing. The line spool retains a predetermined amount of fishing line that can be easily deployed by the user. The plurality of hook-securing channels enables the temporary attachment of a fishing hook connected to the fishing line so that the fishing line does not come loose when not in use. The restraining strap allows the attachment of the device to the user's wrist or another external object.

The current application claims a priority to the U.S. provisional patent application Ser. No. 63/644,945 filed on May 9, 2024.

### FIELD OF THE INVENTION

The present invention generally relates to fishing gear and wearable devices. More specifically, the present invention discloses a fishing reel that can be worn by the user on the wrist to be able to fish anywhere without having to carry a fishing rod or tackle boxes.

### BACKGROUND OF THE INVENTION

Generally, fishing rods tend to be long and slender rods that range from 4 to 14 feet long. The great length can cause fishing rods to get hung-up on objects and be more prone to damage. In addition, an angler must plan and gather all the equipment needed before leaving to find a fishing spot. A large tackle box is used to store all the fishing tackle, which can be diverse. The chosen tackle is dependent on the species of the target fish and the habitat in which the target fish live. Most anglers have a favorite spot and fish for common species. Moreover, a lot of tackles can go unused for long periods of time when fishing the same spot and the same species of fish. An angler can usually bring basic tackle and rod, but the fishing rod can be cumbersome to bring and set up for an inexperienced angler. Further, trying to thread the fishing line through the fishing rod guides while keeping the fishing line on the spool from tangling can be precarious. Therefore, a more practical alternative is necessary that can be comfortably transported and can be easily used by any person.

Therefore, an objective of the present invention is to provide a wearable fishing reel that is more practical and easier to use than traditional fishing rods. The present invention can be comfortably worn by the user to be used at any time for simple fishing. Another objective of the present invention is to provide a wearable fishing reel that can be easily utilized by the user. The present invention is designed so that the user does not have to thread fishing line through a series of guides. Another objective of the present invention is to provide a wearable fishing reel that allows the user to carry fishing gear in a practical and comfortable manner. The present invention allows the user to carry fishing equipment anywhere which enables the user to fish whenever the opportunity arises.

Another objective of the present invention is to provide a wearable fishing reel that does not restrict the movement of the user. The present invention can store tackle in an accessible manner that allows the user to be more mobile and have access to the essential tackle. Additional features and benefits of the present invention are further discussed in the sections below.

### SUMMARY OF THE INVENTION

The present invention discloses a wearable fishing reel. The wearable fishing reel is preferably worn on the wrist so that the user can carry the present invention comfortably. The present invention has a practical design that allows any user to easily fish regardless of the user's experience. To do so, the present invention generally comprises a support base, a line spool, and a restraining strap. The support base serves as the intermediate structure that connects the line spool to the restraining strap. The restraining strap allows the present invention to be fastened to the user's wrist comfortably. In addition, the restraining strap allows the present invention to be attached to external objects, such as a post, tree branch, beverage can, etc. The line spool allows the user to easily perform simple fishing without using a traditional fishing rod by retaining the necessary fishing line and fishing hook. Moreover, the line spool can be designed as a fixed reel that requires the user to manually spool the fishing line or as a spinning reel that the user can engage to spool the fishing line. In other embodiments, the present invention can include other features that increase the overall functionality of the wearable fishing reel.

### BRIEF DESCRIPTION OF THE DRAWINGS

FIG. 1 is a top-front-left perspective view of the present invention, wherein the restraining strap of the present invention is shown unfastened.

FIG. 2 is a bottom-front-left perspective view of the present invention thereof.

FIG. 3 is a top-front-left perspective view of the present invention, wherein the restraining strap of the present invention is shown fastened.

FIG. 4 is a bottom-rear-right perspective view of the present invention thereof.

FIG. 5 is a top-front-left perspective view of the present invention thereof, wherein accessory holders are shown attached to the restraining strap of the present invention.

FIG. 6 is a top view of the present invention, wherein the line spool of the present invention is shown without the restraining strap.

FIG. 7 is a front view of the present invention thereof.

FIG. 8 is a top-front-right perspective view of an alternate embodiment of the present invention, wherein the line spool of the present invention is shown as a spinning line spool.

FIG. 9 is a bottom-rear-left perspective view of the alternate embodiment of the present invention thereof.

### DETAILED DESCRIPTION OF THE INVENTION

All illustrations of the drawings are for the purpose of describing selected versions of the present invention and are not intended to limit the scope of the present invention.

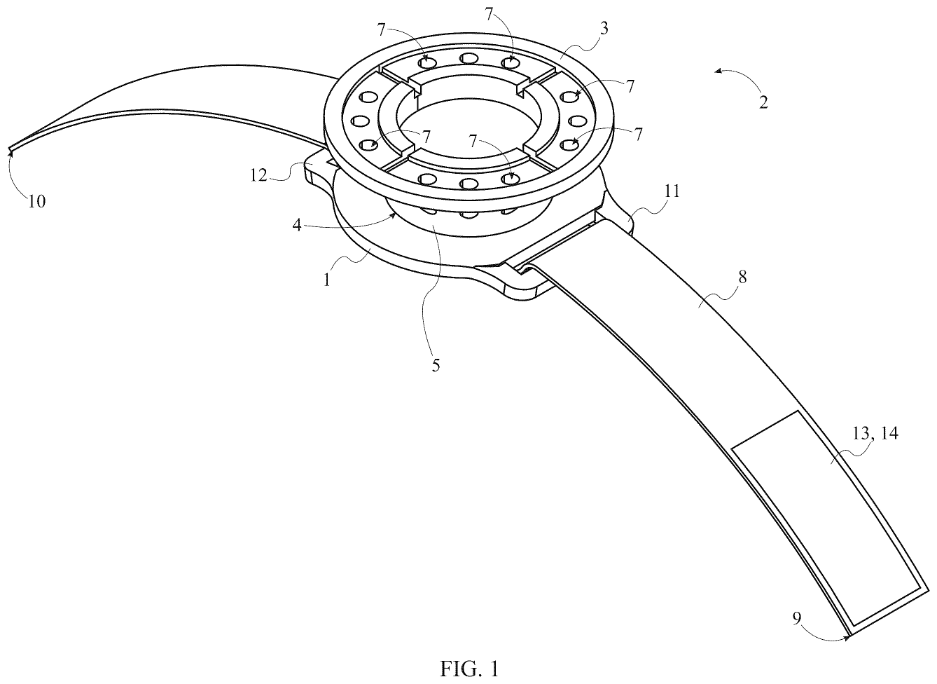

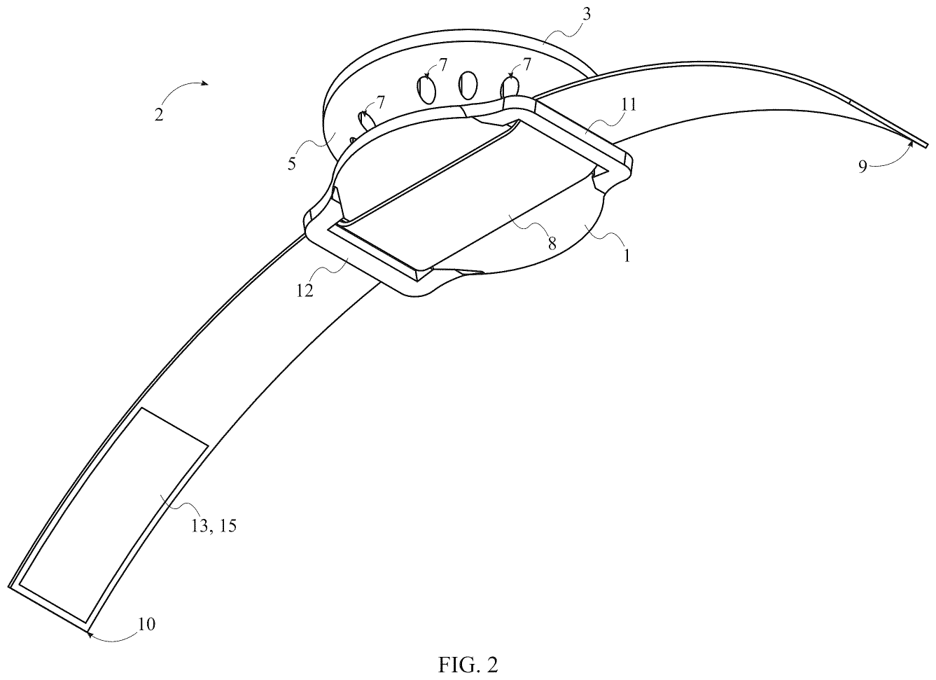

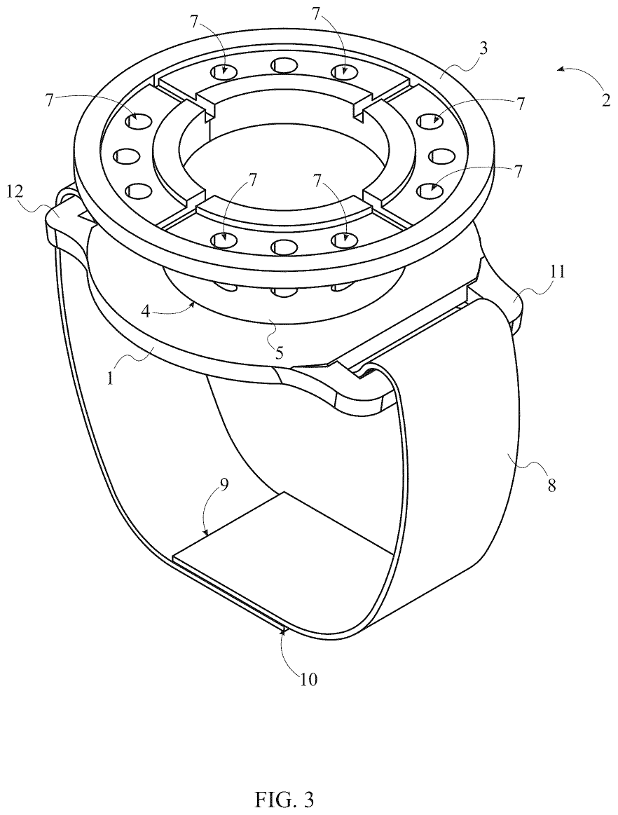

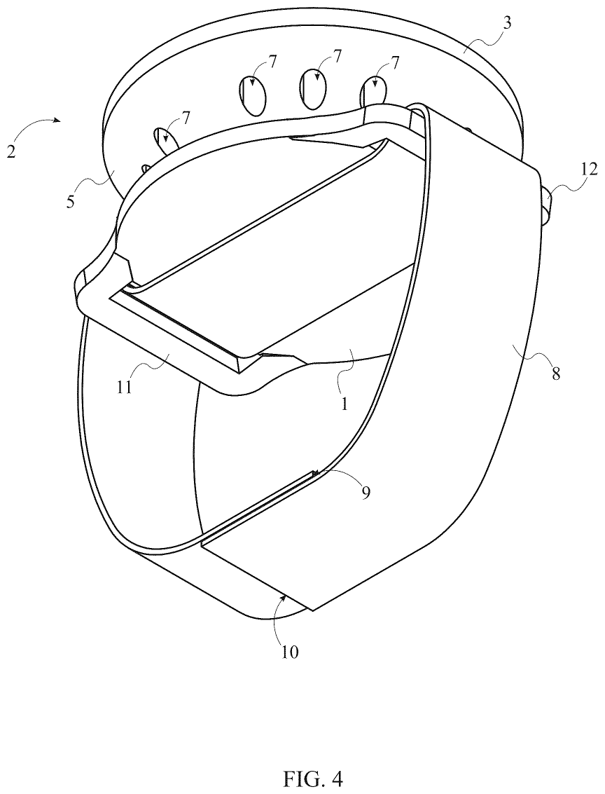

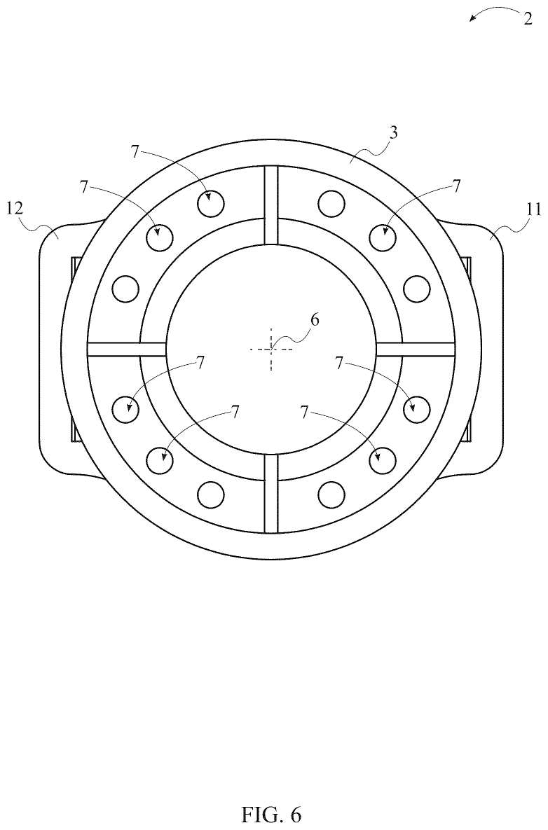

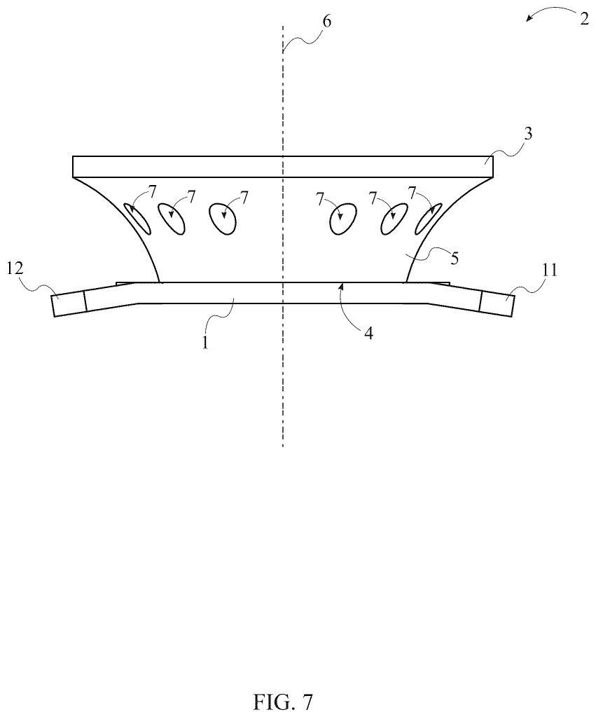

The present invention discloses a wearable fishing reel. The wearable fishing reel can be comfortably worn by the user so that the user can perform simple fishing anywhere anytime. As can be seen in FIGS. 1 through 7, the present invention comprises a support base 1, a line spool 2 a plurality of hook-securing channels 7, and a restraining strap 8 The support base 1 corresponds to the structure that facilitates the attachment of the restraining strap 8 to the present invention. The support base 1 also facilitates the operation of the line spool 2 The line spool 2 retains a predetermined amount of fishing line that can be easily deployed by the user when desired. The plurality of hook-securing channels 7 enables the selective attachment of a fishing hook connected to the fishing line spooled around the line spool 2 so that the fishing line does not come loose when not in use. The restraining strap 8 allows the attachment of the present invention to the user's wrist or another external object.

The general configuration of the aforementioned components allows the user to perform simple fishing anytime without having to carry a fishing rod or a tackle box. As previously discussed, the line spool 2 is designed to retain the fishing line in a readily available manner so that the user can perform simple fishing when desired. As can be seen in FIGS. 1 through 7, the line spool 2 generally comprises a first spool base 3, a second spool base 4, and a spool lateral wall 5. The first spool base 3 and the second spool base 4 correspond to the round bases of the line spool 2 The spool lateral wall 5 corresponds to the lateral round surface of the line spool 2 that retains the line spool 2 when the line spool 2 is stored. Moreover, the restraining strap 8 corresponds to an elongated, flat, and flexible structure that allows the present invention to be easily attached to the user's wrist or a desired external object. So, the restraining strap 8 comprises a first strap end 9 and a second strap end 10 corresponding to the terminal ends of the restraining strap 8.

In general, the present invention can be arranged as follows: the first spool base 3 and the second spool base 4 are positioned opposite to each other about the spool lateral wall 5 due to the overall cylindrical structure of the line spool 2 as can be seen in FIGS. 1 through 7. In addition, the spool lateral wall 5 tapers from the first spool base 3 to the second spool base 4. The tapering of the spool lateral wall 5 facilitates the fishing line to be winded up for storage and facilitates the deployment of the fishing line when desired. Further, each of the plurality of hook-securing channels 7 traverses through the first spool base 3 and out of the spool lateral wall 5 to form several openings through which a fishing hook can be inserted. The plurality of hook-securing channels 7 is also radially distributed about a central axis 6 of the line spool 2 to evenly distribute the plurality of hook-securing channels 7 about the line spool 2 The radial distribution of the plurality of hook-securing channels 7 ensures that a hook-securing channel is always available adjacent to where the fishing hook is positioned once the fishing line is spooled. Further, the second spool base 4 is centrally mounted onto the support base 1 to secure the line spool 2 to the support base 1 In addition, the restraining strap 8 is attached against the support base 1, opposite to the support base 1 to secure the restraining strap 8 to the support base 1 In other embodiments, the present invention can be rearranged to accommodate other features.

As previously discussed, the restraining strap 8 is designed to facilitate the attachment of the present invention to the user's wrist or an external object. In the preferred embodiment, the restraining strap 8 is designed to allow the user to wear the present invention as a wristwatch. As can be seen in FIGS. 1 through 7, the present invention may further comprise a first strap eyelet 11 and a second strap eyelet 12 that facilitate the attachment of the restraining strap 8 to the support base 1 The first strap eyelet 11 and the second strap eyelet 12 are designed so that the restraining strap 8 has some freedom of movement to not cause discomfort to the user's wrist.

In the preferred embodiment, the first strap eyelet 11 and the second strap eyelet 12 can be implemented as follows: the first strap eyelet 11 is peripherally connected to the support base 1 to position the first strap eyelet 11 along the perimeter of the support base 1 as can be seen in FIGS. 1 through 7. Similarly, the second strap eyelet 12 is peripherally connected to the support base 1, opposite the first strap eyelet 11, to position the second strap eyelet 12 opposite the first strap eyelet 11 along the perimeter of the support base 1 Further, the restraining strap 8 is looped through the first band eyelet and the second band eyelet to secure the restraining strap 8 to the support base 1 using the first strap eyelet 11 and the second strap eyelet 12 In other embodiments, different mechanisms can be implemented to facilitate the attachment of the restraining strap 8 to the support base 1

As previously discussed, the restraining strap 8 is designed to enable the user to wear the present invention as a wrist watch. For example, the restraining strap 8 can be a closed-loop elastic strap that can be stretched so that the present invention can be positioned around the user's wrist. The restraining strap 8 can also be provided as a non-elastic strap for greater durability and that can be replaced as desired. As can be seen in FIGS. 1 through 7, to accommodate a non-elastic restraining strap 8, the restraining strap 8 may comprise a first strap end 9 and a second strap end 10 corresponding to the terminal free ends of the restraining strap & In addition, the present invention may further comprise a strap fastener 13 that allows the selective fastening of the first strap end 9 to the second strap end 10. Further, the strap fastener 13 may comprise a first interlocking piece 14 and a second interlocking piece 15 corresponding to two interlocking pieces of the strap fastener 13

This embodiment of the restraining strap 8 can be implemented as follows: the first interlocking piece 14 is laterally connected to the strap fastener 13, adjacent to the first strap end 9, to secure the first interlocking piece 14 to the restraining strap 8, as can be seen in FIGS. 1 through 7. Similarly, the second interlocking piece 15 is laterally connected to the strap fastener 13, adjacent to the second strap end 10, to secure the second interlocking piece 15 to the restraining strap & Further, to engage the strap fastener 13, the first interlocking piece 14 and the second interlocking piece 15 can be releasably engaged to each other. For example, the strap fastener 13 can be a hook-and-loop fastener, wherein the first interlocking piece 14 can correspond to the hook portion, and the second interlocking piece 15 can correspond to the loop portion. In other embodiments, different types of fasteners can be implemented for different types of restraining straps.

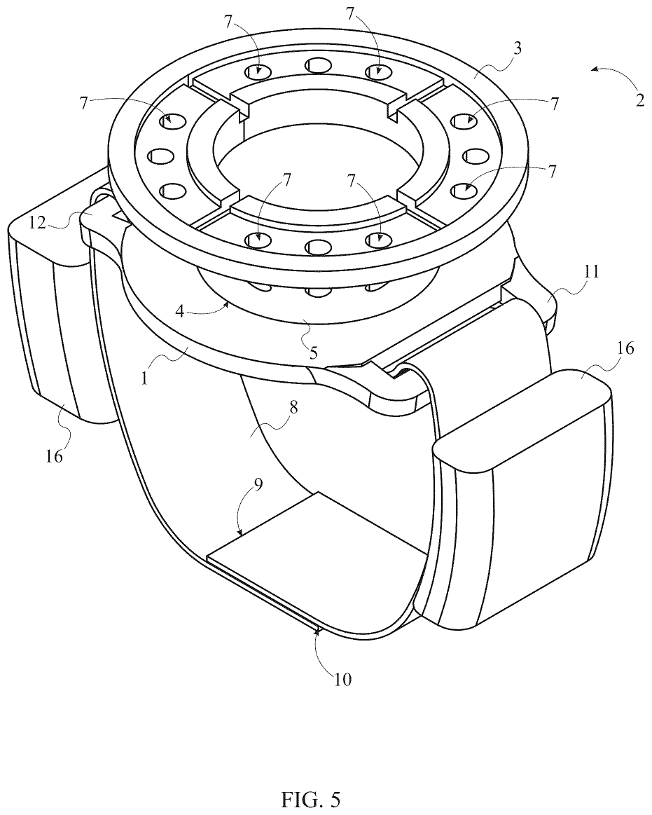

To further enable the user to carry the necessary tools for simple fishing, the present invention may further comprise at least one accessory holder 16. As can be seen in FIG. 5, the at least one accessory holder 16 corresponds a small structure that can be attached to the restraining strap 8 to retain different types of fishing accessories. For example, the at least one accessory holder 16 can be a small pouch that can be used to carry several tackles that can be used for simple fishing. The at least one accessory holder 16 can also be a smaller strap that retains a cord or additional fishing line. Generally, the at least one accessory holder 16 is laterally connected to the restraining strap 8, offset from the support base 1, to secure the at least one accessory holder 16 to the restraining strap 8 Several accessory holders can be attached along the restraining strap 8 to comfortably carry different fishing accessories along with the present invention. In other embodiments, different mechanisms can be implemented to secure other fishing accessories to the present invention for ease of transportation.

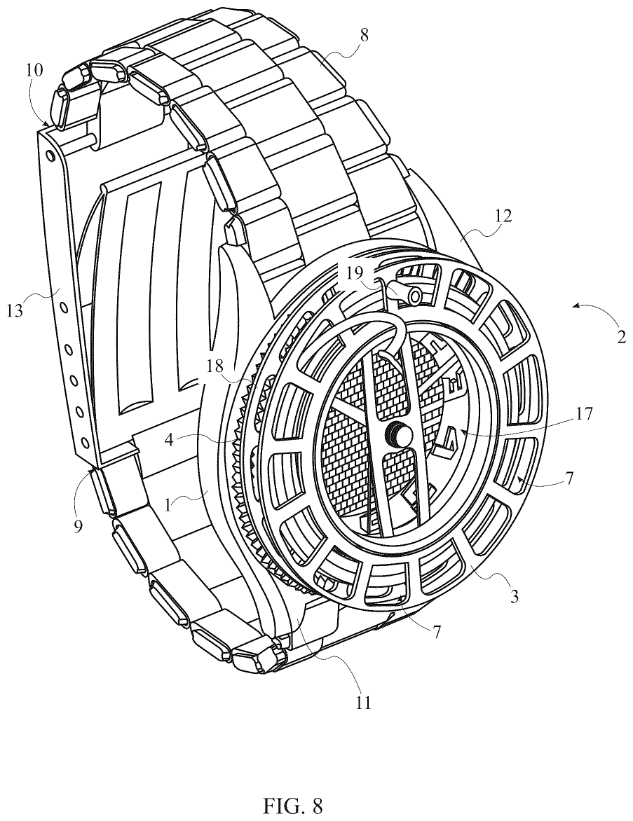

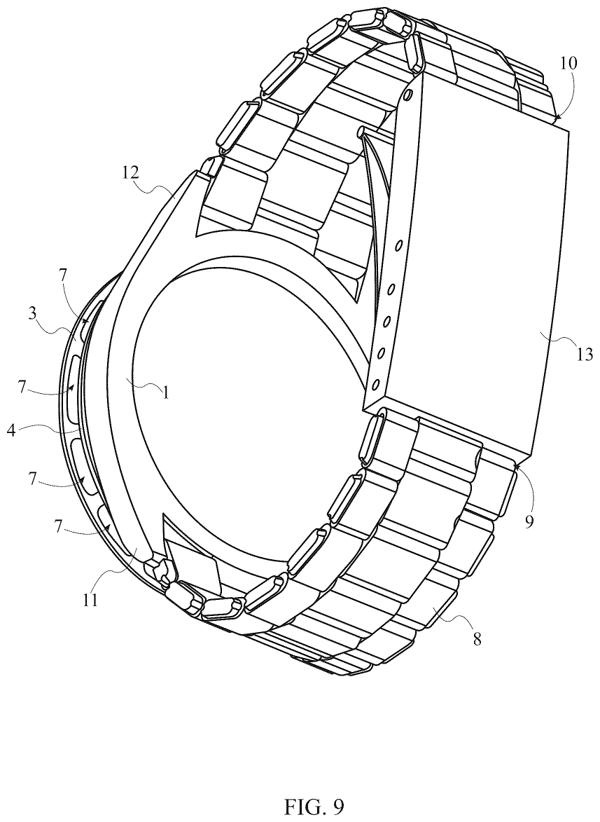

As previously discussed, different features can be implemented to increase the overall functionality of the present invention. In one embodiment, the present invention may further comprise a watch mechanism 17 implemented on the line spool 2 as can be seen in FIGS. 8 and 9. The watch mechanism 17 can be operatively integrated into the first spool base 3 to implement the watch mechanism 17 into the line spool 2 The watch mechanism 17 is used to display the current time on the first spool base 3. For example, the watch mechanism 17 can be implemented within a central recession on the first spool base 3 so that the watch mechanism 17 does not obstruct the operation of the line spool 2 The watch mechanism 17 includes the general components of a mechanical watch such as the watch hands, the gear train, etc. Additional components of the watch mechanism 17 can be implemented as necessary on the line spool 2

In an alternate embodiment, the line spool 2 can be provided as a spinning spool instead of a fixed spool to facilitate the spooling of the fishing line, as can be seen in FIGS. 8 and 9. The spinning embodiment of the line spool 2 is designed to allow the line spool 2 to rotate on the support base 1 So, the second spool base 4 is rotatably connected to the support base 1 to allow the line spool 2 to spin on the support base 1 In addition, due to the spinning of the line spool 2 the present invention may further comprise an annular base guard 18 that keeps the fishing line around the spool lateral wall 5. The annular base guard 18 is connected around the second spool base 4 to separate the fishing line from the support base 1

As can be seen in FIGS. 8 and 9, the spinning embodiment of the line spool 2 can include different features that help the operation of the spinning line spool 2 For example, the present invention may further comprise a spool handle 19. The spool handle 19 can be a collapsible handle that is used to rotate the line spool 2 To do so, the spool handle 19 is eccentrically positioned to the first spool base 3 to facilitate the rotation of the line spool 2 with the spool handle 19. Further, the spool handle 19 is rotatably connected to the first spool base 3 to secure the spool handle 19 to the line spool 2 The rotational connection of the spool handle 19 to the first spool base 3 further facilitates the rotation of the line spool 2 with the spool handle 19.

Further, the spinning embodiment of the line spool 2 may further comprise a drag mechanism. The drag mechanism corresponds to a mechanical device that can be tightened or loosened to adjust the resistance on the spinning of the line spool 2 The drag mechanism allows the user to increase resistance to the line spool 2 to help tire a hooked fish when fishing or to decrease resistance to the line spool 2 when reeling the fish toward the user. The line spool 2 is rotatably connected to the support base 1 by the drag mechanism so that the drag mechanism can alter the rotation of the line spool 2 on the support base 1 Further, the spinning embodiment of the line spool 2 may further comprise a latch mechanism that is used to selectively prevent the rotation of the line spool 2 when not in use. The latch mechanism can be implemented along with the drag mechanism so that the user can selectively engage either the drag mechanism or the latch mechanism. In other embodiments, additional mechanisms can be implemented to further facilitate the operation of the spinning line spool 2

Although the invention has been explained in relation to its preferred embodiment, it is to be understood that many other possible modifications and variations can be made without departing from the spirit and scope of the invention.

What is claimed is:

1. A wearable fishing reel comprising:
a support base;
a line spool;
a plurality of hook-securing channels;
a restraining strap;
the line spool comprising a first spool base, a second spool base, and a spool lateral wall;
the restraining strap comprising a first strap end and a second strap end;
the first spool base and the second spool base being positioned opposite to each other about the spool lateral wall;
the spool lateral wall tapering from the first spool base to the second spool base;
each of the plurality of hook-securing channels traversing through the first spool base and out of the spool lateral wall;
the plurality of hook-securing channels being radially distributed about a central axis of the line spool;
the second spool base being centrally mounted onto the support base; and
the restraining strap being attached against the support base, opposite to the support base.

2. The wearable fishing reel as claimed in claim 1 further comprising:
a first strap eyelet;
a second strap eyelet;
the first strap eyelet being peripherally connected to the support base;
the second strap eyelet being peripherally connected to the support base, opposite the first strap eyelet; and
the restraining strap being looped through the first band eyelet and the second band eyelet.

3. The wearable fishing reel as claimed in claim 2 further comprising:
a strap fastener;
the restraining strap comprising a first strap end and a second strap end;
the strap fastener comprising a first interlocking piece and a second interlocking piece;
the first interlocking piece being laterally connected to the strap fastener, adjacent to the first strap end;
the second interlocking piece being laterally connected to the strap fastener, adjacent to the second strap end; and
the first interlocking piece and the second interlocking piece being releasably engaged to each other.

4. The wearable fishing reel as claimed in claim 1 further comprising:
at least one accessory holder; and
the at least one accessory holder being laterally connected to the restraining strap, offset from the support base.

5. The wearable fishing reel as claimed in claim 1 further comprising:
a watch mechanism; and
the watch mechanism being operatively integrated into the first spool base, wherein the watch mechanism is used to display a current time on the first spool base.

6. The wearable fishing reel as claimed in claim 1 further comprising:
the second spool base being rotatably connected to the support base.

7. The wearable fishing reel as claimed in claim 6 further comprising:
an annular base guard; and
the annular base guard being connected around the second spool base.

8. The wearable fishing reel as claimed in claim 6 further comprising:
a spool handle;
the spool handle being rotatably connected to the first spool base; and
the spool handle being eccentrically positioned to the first spool base.

9. A wearable fishing reel comprising:
a support base;
a line spool;
a plurality of hook-securing channels;
a restraining strap;
a first strap eyelet;
a second strap eyelet;
the line spool comprising a first spool base, a second spool base, and a spool lateral wall;
the restraining strap comprising a first strap end and a second strap end;
the first spool base and the second spool base being positioned opposite to each other about the spool lateral wall;
the spool lateral wall tapering from the first spool base to the second spool base;
each of the plurality of hook-securing channels traversing through the first spool base and out of the spool lateral wall;
the plurality of hook-securing channels being radially distributed about a central axis of the line spool;
the second spool base being centrally mounted onto the support base;
the first strap eyelet being peripherally connected to the support base;
the second strap eyelet being peripherally connected to the support base, opposite the first strap eyelet; and
the restraining strap being looped through the first band eyelet and the second band eyelet.

10. The wearable fishing reel as claimed in claim 9 further comprising:
a strap fastener;
the restraining strap comprising a first strap end and a second strap end;
the strap fastener comprising a first interlocking piece and a second interlocking piece;
the first interlocking piece being laterally connected to the strap fastener, adjacent to the first strap end;
the second interlocking piece being laterally connected to the strap fastener, adjacent to the second strap end; and
the first interlocking piece and the second interlocking piece being releasably engaged to each other.

11. The wearable fishing reel as claimed in claim 9 further comprising:
at least one accessory holder; and
the at least one accessory holder being laterally connected to the restraining strap, offset from the support base.

12. The wearable fishing reel as claimed in claim 9 further comprising:
a watch mechanism; and
the watch mechanism being operatively integrated into the first spool base, wherein the watch mechanism is used to display a current time on the first spool base.

13. The wearable fishing reel as claimed in claim 9 further comprising:
the second spool base being rotatably connected to the support base.

14. The wearable fishing reel as claimed in claim 13 further comprising:
an annular base guard; and
the annular base guard being connected around the second spool base.

15. The wearable fishing reel as claimed in claim 13 further comprising:
a spool handle;
the spool handle being rotatably connected to the first spool base; and
the spool handle being eccentrically positioned to the first spool base.

16. A wearable fishing reel comprising:
a support base;
a line spool;
a plurality of hook-securing channels;
a restraining strap;
a first strap eyelet;
a second strap eyelet;
a watch mechanism;
the line spool comprising a first spool base, a second spool base, and a spool lateral wall;
the restraining strap comprising a first strap end and a second strap end;
the first spool base and the second spool base being positioned opposite to each other about the spool lateral wall;
the spool lateral wall tapering from the first spool base to the second spool base;
each of the plurality of hook-securing channels traversing through the first spool base and out of the spool lateral wall;
the plurality of hook-securing channels being radially distributed about a central axis of the line spool;
the second spool base being centrally mounted onto the support base;
the first strap eyelet being peripherally connected to the support base;
the second strap eyelet being peripherally connected to the support base, opposite the first strap eyelet;
the restraining strap being looped through the first band eyelet and the second band eyelet; and
the watch mechanism being operatively integrated into the first spool base, wherein the watch mechanism is used to display a current time on the first spool base.

17. The wearable fishing reel as claimed in claim 16 further comprising:
a strap fastener;
the restraining strap comprising a first strap end and a second strap end;
the strap fastener comprising a first interlocking piece and a second interlocking piece;
the first interlocking piece being laterally connected to the strap fastener, adjacent to the first strap end;
the second interlocking piece being laterally connected to the strap fastener, adjacent to the second strap end; and
the first interlocking piece and the second interlocking piece being releasably engaged to each other.

18. The wearable fishing reel as claimed in claim 16 further comprising:
at least one accessory holder; and
the at least one accessory holder being laterally connected to the restraining strap, offset from the support base.

19. The wearable fishing reel as claimed in claim 16 further comprising:
an annular base guard;
the second spool base being rotatably connected to the support base; and
the annular base guard being connected around the second spool base.

20. The wearable fishing reel as claimed in claim 19 further comprising:
a spool handle;
the spool handle being rotatably connected to the first spool base; and
the spool handle being eccentrically positioned to the first spool base.
